(19) United States
(12) Patent Application Publication
(10) Pub. No.: US 2023/0123732 A1
(43) Pub. Date: Apr. 20, 2023

(54) PROGRAMMABLE KEYBOARD SYSTEM

(71) Applicant: KING FAISAL UNIVERSITY, AL-AHSA (SA)

(72) Inventor: SLIM CHTOUROU, AL-AHSA (SA)

(21) Appl. No.: 17/505,585

(22) Filed: Oct. 19, 2021

(51) Int. Cl. G06F 3/023

(52) U.S. Cl. CPC G06F 3/0238; G06F 3/0231

(57) ABSTRACT

A programmable keyboard receiver adapted to perform a function on a computer when a key is pressed on a keyboard. The programmable keyboard receiver includes: a programmable keyboard receiver input that receives a keyboard key signal from the keyboard when the key is pressed; a programmable keyboard receiver processor that associates the keyboard key signal with a keystroke to type on the computer; a programmable keyboard receiver output that sends an output signal to the computer; and a processor that associates the keystroke with the function to perform on the computer.

### BACKGROUND

### 1. Field

This disclosure relates to computer user interfaces, and particularly to a programmable keyboard system that has a receiver for programming functions or making macros for inputs, such as key strokes made through input devices, such as keyboards, keypads, smart phones, and other input devices.

### 2. Description of the Related Art

Function keys are a useful way to perform functions by simply pressing a function key on an input device, such as a keyboard. Keyboard manufacturers pre-program the function keys to perform pre-defined functions. These pre-programmed function keys provide useful shortcuts to perform various functions, such as opening apps, adjusting sound, volume or brightness, printing, pulling up help screens etc. In many instances, keyboard manufacturers have programmed many shortcuts into the function keys. These shortcuts are useful in increasing productivity and making the users experience more convenient. These days, there are more programs, applications and types of inputs that are used every day. It is almost impossible for a manufacturer to anticipate the numerous functions and keystrokes that a user may use in the multitude of new applications and input devices. Additionally, users have personal preferences and keystrokes that they find convenient in different applications and when using different input devices.

Thus, a programmable keyboard system solving the aforementioned problems is desired.

### SUMMARY

In one embodiment, the programmable keyboard system is a programmable keyboard receiver adapted to perform a function on a computer when a key is pressed on a keyboard. The programmable receiver includes: a programmable keyboard receiver input that receives a keyboard key signal from the keyboard when the key is pressed; a programmable keyboard receiver processor that associates the keyboard key signal with a function to perform on the computer; and a programmable keyboard receiver output that sends an output signal to the computer to perform the function on the computer.

The programmable keyboard receiver may further include a keyboard having a signal generator and an output. The signal generator generates the keyboard key signal when the key is pressed. The output sends the keyboard key signal to the programmable keyboard receiver input. The programmable keyboard could be a smartphone or a tablet.

In an alternative embodiment, the programmable keyboard receiver is a device pluggable into the computer and can receive signals wirelessly. This can be accomplished using Bluetooth, WiFi, or other types of communication protocols. The pluggable device can be a USB device or any other type of device that can be connected to a computer, either directly or wirelessly.

In other embodiments the programmable keyboard receiver is resident within the computer.

The programmable keyboard system can also be a method to perform a function on a computer when a key is pressed on a keyboard. The method includes: receiving, in a programmable keyboard receiver, a signal from the programmable keyboard when the key is pressed; associating, in the programmable keyboard receiver, the signal with a function to perform on the computer; and sending, from the programmable keyboard receiver, an output signal to the computer to perform the function on the computer.

In another embodiment, the programmable keyboard system includes: a keyboard having a plurality of keys; an input that receives a keyboard key signal from the keyboard when the key is pressed and sends it to the programmable keyboard receiver; a lookup table that associates the keyboard key signal with a function to perform on the computer; and an output that sends an output signal to the computer to perform the function on the computer.

In some embodiments the input, lookup table and output are resident in a USB device. The USB device in one example can receive signals wirelessly through Bluetooth or WiFi.

In other embodiments, the input, lookup table and output are resident within the computer.

These and other features of the present subject matter will become readily apparent upon further review of the following specification.

### BRIEF DESCRIPTION OF THE DRAWINGS

FIG. 1 is a block diagram of a programmable keyboard system wirelessly communicating with a remote keypad.

FIG. 2 is a block diagram of a programmable keyboard system wirelessly communicating with a keyboard.

FIG. 3 is a block diagram of a programmable keyboard system communicating with a wired keyboard.

FIG. 4 is a flowchart illustrating the steps in performing a function on a computer when a key is pressed on an input device, such as a keyboard.

FIG. 5 is an exemplary screenshot of a software user interface for the programmable keyboard system.

Similar reference characters denote corresponding features consistently throughout the attached drawings.

### DETAILED DESCRIPTION OF THE PREFERRED EMBODIMENTS

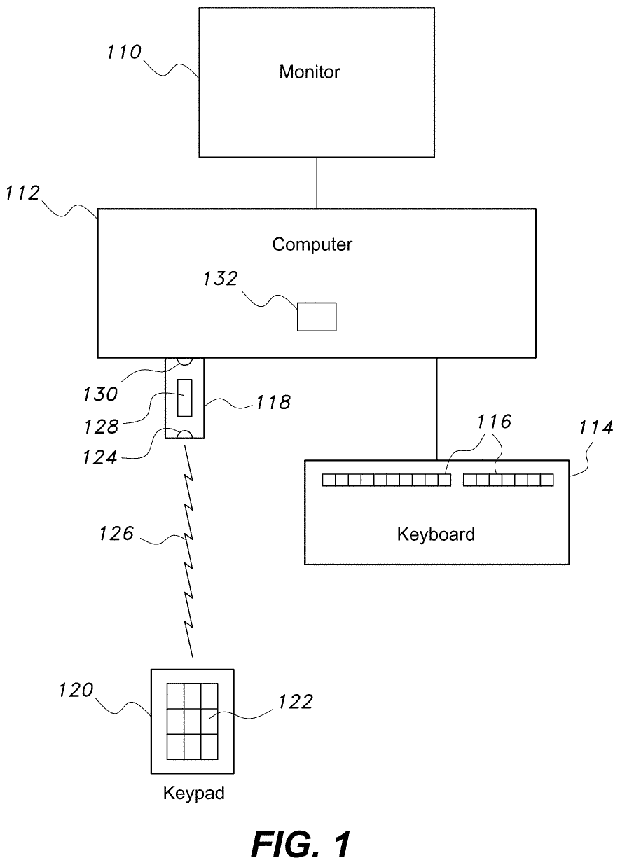

FIG. 1 shows an embodiment of a programmable keyboard system wirelessly communicating with a remote keypad, which may be incorporated into a smartphone, tablet, or other device. The illustration depicts a monitor 110 connected to a computer 112. An input device, such as a keyboard 114, is connected to the computer 112. The keyboard 114 has a plurality of function keys 116. The function keys 116 are pre-programmed to execute certain functions or macros pre-defined by the manufacturer. Some examples may be to display a help screen, highlight a file or folder for renaming, or open a search tool. In operation, when a function key, such as F1, is pressed, a help screen is displayed on the monitor 110. When a function key, such as F2, is pressed, a file or folder is highlighted on the monitor 110 for renaming. When a function key, such as F3, is pressed, a search tool is opened and displayed on the monitor 100.

These days, there are more programs, applications and types of inputs that are used every day. It is almost impossible for a manufacturer to anticipate the numerous functions and keystrokes that a user may use in the multitude of new applications and input devices. Additionally, users have personal preferences and keystrokes that they find convenient in different applications and when using different input devices. There is a need for a programmable keyboard system that allows for programming of multiple function keys to execute a variety of functions and key strokes. A user could then program function keys with useful shortcuts, thereby enhancing the user's experience and productivity.

In one embodiment, a receiver 118 is connected to the computer 112. The receiver 118 may be plugged into the computer 112 via a USB port or any other type of input/output port. In other embodiments, the receiver 118 is connected to the computer 112 with a wire via an input/output port on the computer 112. The receiver 118 can be a USB device that communicates with other devices wirelessly via Bluetooth, WiFi, or any other communication protocol. In other embodiments, the receiver 118 is connected to other devices via a wire.

An input device 120, as illustrated, communicates with the receiver 118 wirelessly. The receiver 118 can be a programmable keyboard receiver adapted to perform a function on a computer when a key is pressed on the input device 120. The receiver 118 includes a programmable keyboard receiver input 124 that receives a keyboard key signal 126 from the input device 120 when one of the function keys 122 is pressed; a programmable keyboard receiver processor 128 that includes instructions to associate the keyboard key signal 126 with a keyboard keystroke to perform on the computer 112; and a programmable keyboard receiver output 130 that sends an output signal to the computer 112 to be processed on the computer 112.

The programmable keyboard receiver processor 128 includes instructions to match the keyboard key signal 126 with a keyboard keystroke (lookup table) to execute on the computer 112. Once the keystroke to execute on the computer 112 is determined via the lookup table, the programmable keyboard receiver processor 128 sends instruction via the programmable keyboard receiver output 130 to execute the keystroke on the computer 112. The keystroke will be associated in the computer with a function or sequence of keystrokes. These functions or keystrokes can be any type of function, keystrokes or macro that is desired by the user. For example, the function, keystrokes or macro may be to open a folder, open a website, copy text and display a media file, etc.

The computer 112 includes a processor 132 that is used to associate and program the programmable keyboard receiver processor 128 to execute various functions, keystrokes and/or macros when one of the function keys 122 is pressed. In some embodiments, the programmable keyboard receiver processor 128 is pre-programmed and can be re-programmed to change the keystrokes executed when one of the function keys 122 is depressed.

In alternative embodiments, the processor 132 can be re-programmed to change the functions executed when the keyboard key signal 126 is sent via the programmable keyboard receiver output 130. The processor 132 receives the keyboard signal 126 from the programmable keyboard receiver processor 128 via the programmable keyboard receiver output 130. The processor 132 includes instructions to lookup the keyboard key signal 126 and match it with a function or keystrokes to execute on the computer 112.

To the extent that the function keys 116 are programmable, they can be re-programmed using the processor 132 or the programmable keyboard receiver processor 128 to execute functions or keystrokes on the computer 112 as desired by the user.

In some embodiments, the receiver 118 includes the input device 120. In other embodiments, the receiver includes the instructions of the processor 132. It is also conceivable that the receiver 118 includes both the input device 120 and the instructions of processor 132.

The user, in some embodiments, will be able to press the real function keys F13-F24, which are defined in Microsoft MSDN documentation as virtual keys VK_F13 to VK_F24 (identified in programs as the values 0x73c to 0x87)

While the proposed hardware keyboard offers the F13-F24 keys, not only does the receiver assign a task to these keys, but indeed, it can give a second role to any key (or key combination) and works with any keyboard, not just macro keyboards. Therefore, even regular keyboards and laptop keyboards can get a productivity boost. For example, Ctrl+Alt+F1 can be programmed to open a file on the user's computer. For example, the processor 132 or the programmable keyboard receiver processor 128 will conserve the role of the function keys 116 and add a second role to them to allow functions or keystrokes to execute on the computer 112 as desired by the user in addition to their existing role.

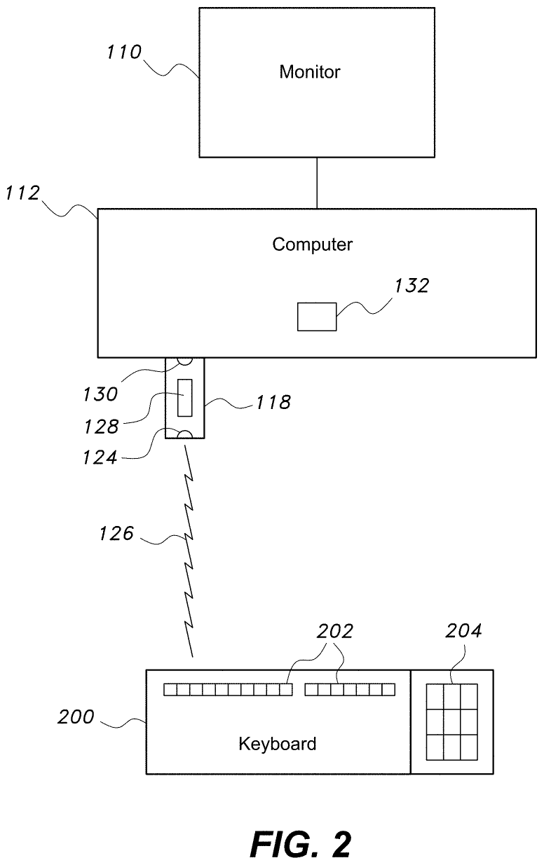

FIG. 2 shows a keyboard macro system wirelessly communicating with a keyboard. The components and operation are the same as described in relation to FIG. 1, except for the input device. This embodiment includes an input device 200 having function keys 202 and 204 that wirelessly communicate with the receiver 118. When one of the function keys 202,204 is pressed, a keyboard key signal 126 is sent to the receiver 118. The operation of the receiver is the same as described in relation to FIG. 1.

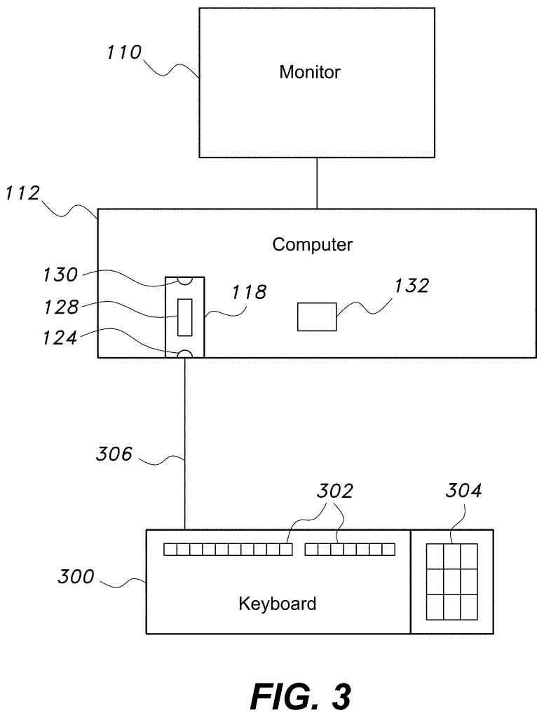

FIG. 3 shows a programmable keyboard system communicating with a wired keyboard. The components and operation are the same as described in relation to FIG. 1, except for the input device. A keyboard 300 is used as the input device and includes function keys 302 and 304. The keyboard 300 is connected to the receiver 118 through a wire 306. When one of the function keys 302,304 is pressed, a keyboard key signal is sent to the programmable keyboard receiver input 124 via the wire 306. The operation of the receiver is the same as described in relation to FIG. 1. It is noted that the instructions to associate the keyboard key signal with a function to perform on the computer 112 may be resident in the processor 132.

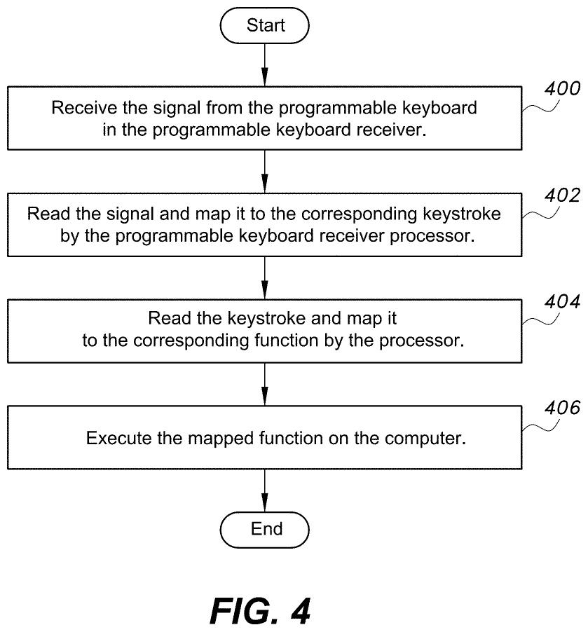

FIG. 4 is a flowchart illustrating the steps in performing a function on a computer when a key is pressed on an input device, such as a keyboard. In step 400 a signal from the programmable keyboard 120,200,300 is received in the programmable keyboard receiver 118 when a key 122,202,302,304 is pressed. In step 402 the programmable keyboard receiver processor 128 has instructions that associate the signal with a keystroke to type. In step 404, the processor 132 reads the keystroke signal and associates it with a function to perform on the computer (lookup table). In step 406, an output signal to perform a function is sent to the computer 112.

In some embodiments, the method is performed within the computer. For example, the processor 132 includes the instructions that associate the signal with a function to perform on the computer.

The programmable keyboard system as described herein can be a mix of hardware and software that is compatible with existing keyboards, whether regular or macro. A new role to any keyboard key can be added with the easy to use software. It is also possible to use wireless commands to obtain infinite key assignments.

It is noted that the input device is not limited to a keyboard or key-pad. Other inputs, such as a smartphone, tablet, remote control or other input device, can be used. The programmable keyboard system as described herein will work with all keyboards. Thus, there is no need to include a proprietary input device/keyboard. Additionally, the user interface is friendly and easy to use, even by non tech-savvy users. In some embodiments only a USB device receives commands by WiFi and translates them by sending the corresponding keyboard press. Thus, it is available to send keyboard keys to the computer from any other WiFi-enabled device, such as smartphones, tablets etc. In this model, the physical keys are replaced by software commands, which allows infinite number of tasks to be configured on the PC's developed application.

This programmable keyboard provides additional keys to the user's existing keyboard that he can use to boost his productivity while working on a computer by allowing him to access any data from his computer or from the Internet, no matter its location, with a simple press of a button.

The programmable keyboard, in one embodiment, includes a hardware part and a software part. The hardware part is composed of an ATmega32u4 microcontroller, which can act as a keyboard. A 4×3 keypad is attached to it, and whenever a button is pressed, a particular keyboard key press will be sent to the computer. The chosen keys are the functions F13-F24, which are not used by any program, since almost all regular computers and laptops have only the F1-F12 function keys. The software part will detect if any of these particular keyboard keys has been pressed. The user can define what action to do for each key. Some of the function are to open a file, open a folder, open a website, copy text, display a media file (image/audio/video).

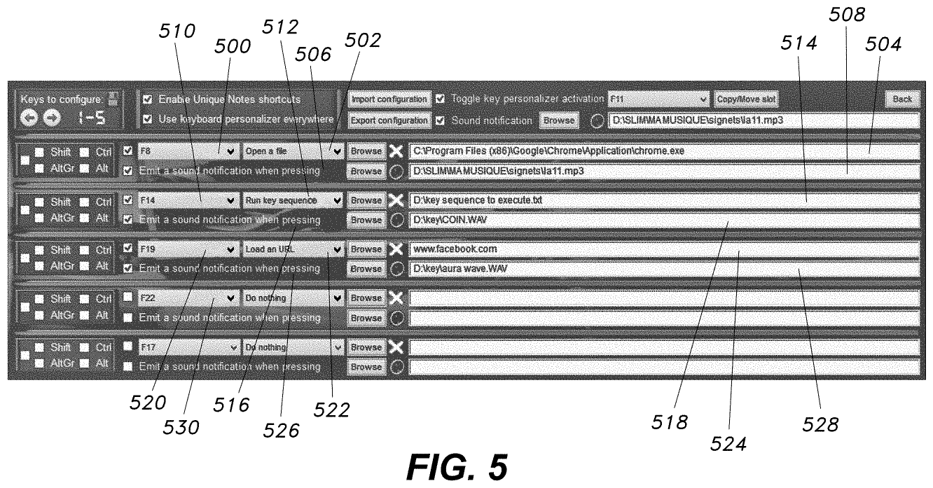

FIG. 5 shows a software user interface for a programmable keyboard system, which allows for easy configuration and programming of keys, such as function keys. Field 500 indexes the entries associated with function key F8. Field 502 shows that F8 is programmed to open a file. The location of the file is shown in field 504. Field 506 shows that F8 will emit a sound when pressed, and field 508 shows the location of the sound file. Thus, when F8 is pressed, it will emit a sound and open a file.

Field 510 indexes entries associated with function key F14. Field 512 shows that when function key F14 is pressed, a pre-determined key configuration will be executed. The file that stores this key configuration to execute is shown in field 514. Field 516 shows that F14 will emit a sound when pressed, and field 518 shows the location of the sound file. When F14 is pressed, a sound will be emitted, and the key sequence stored in the location shown in field 514 will be executed.

Field 520 indexes entries associated with function key F19. Field 522 shows that when function key 520 is pressed, a URL will be loaded. Field 524 shows the location of the URL. Field 526 shows that a sound will be emitted when function key F19 is pressed, and field 528 shows the location of the sound file. When function key F19 is pressed, a sound will be emitted, and the URL identified in field 524 will be opened.

Field 530 indexes entries associated with function key F22. None of the fields includes any entries, which means that F22 has not been programmed to execute a function or emit a sound when pressed.

It is to be understood that the programmable keyboard system is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A programmable keyboard receiver adapted to perform a function on a computer when a key is pressed on a keyboard having a keyboard map, the programmable keyboard receiver comprising:
a programmable keyboard receiver input that receives a keyboard key signal from the keyboard when the key is pressed;
a programmable keyboard receiver processor that through the use of a lookup table associates the keyboard key signal with a new user defined key sequence function using the keyboard map, to be processed on the computer; and
a programmable keyboard receiver output that sends an output signal to a processor within the computer to execute the user defined function on the computer.

2. The programmable keyboard receiver as recited in claim 1, wherein the keyboard further comprises a signal generator and an output, the signal generator generating the keyboard key signal when the key is pressed and the output sending the keyboard key signal to the programmable keyboard receiver input.

3. The programmable keyboard receiver as recited in claim 2, wherein the keyboard is a smart phone.

4. The programmable keyboard receiver as recited in claim 2, wherein the keyboard is a tablet.

5. The programmable keyboard receiver as recited in claim 1, wherein the programmable keyboard receiver is a device pluggable into the computer and that receives signals wirelessly.

6. The programmable keyboard receiver as recited in claim 5, wherein the device receives signals wirelessly through Bluetooth or WiFi.

7. The programmable keyboard receiver as recited in claim 5, wherein the device is a USB device.

8. The programmable keyboard receiver as recited in claim 1, wherein the programmable keyboard receiver is resident within the computer.

9. A method to perform a function on a computer when a key is pressed on a keyboard having a keyboard map, the method comprising:
receiving, in a programmable keyboard receiver, a signal from the programmable keyboard when the key is pressed;
associating, in the programmable keyboard receiver through the use of a lookup table, the signal with a new user defined key sequence function using the keyboard map to send to the computer;
sending, from the programmable keyboard receiver, an output signal to a processor in the computer to perform the user key sequence defined function on the computer.

10. The method as recited in claim 9, wherein the programmable keyboard receiver is a device pluggable into the computer and receives signals wirelessly.

11. The method as recited in claim 10, wherein the device receives signals wirelessly through Bluetooth or WiFi.

12. The method as recited in claim 10, wherein the device is a USB device.

13. The method as recited in claim 9, wherein the programmable keyboard receiver is resident within the computer.

14. The method as recited in claim 9, wherein the keyboard is a smartphone.

15. The method as recited in claim 9, wherein the keyboard is a tablet.

16. A programmable keyboard system comprising:
a keyboard having a keyboard map of a plurality of keys;
an input that receives a keyboard key signal from the keyboard when the key is pressed;
a lookup that associates through the use of a lookup table the keyboard key signal with a new user defined key sequence function using the keyboard map to perform on the computer; and
an output that sends an output signal to a processor in the computer to perform the user defined function on the computer.

17. The programmable keyboard system as recited in claim 16, wherein the input, lookup and output are resident in a USB device.

18. The programmable keyboard system as recited in claim 17, wherein the USB device receives signals wirelessly through Bluetooth or WiFi.

19. The programmable keyboard system as recited in claim 16, wherein the input. lookup and output are resident within the computer.

20. The programmable keyboard system as recited in claim 16, wherein the keyboard is a smartphone.
